(19) United States
(12) Patent Application Publication
(10) Pub. No.: US 2008/0143101 A1
(43) Pub. Date: Jun. 19, 2008

(54) Subsea Mechanical Joint

(76) Inventor: Robert J. Logan, Houston, TX (US)

Correspondence Address: BUSKOP LAW GROUP, P.C., 4511 Dacoma Street, HOUSTON, TX, 77092, US

(21) Appl. No.: 11/612,362

(22) Filed: Dec. 18, 2006

(51) Int. Cl. F16L 13/11

(52) U.S. Cl. 285/21.3

(57) ABSTRACT

A tubular subsea mechanical joint having a first tubular member. The first tubular member has a bell end disposed a first tubular body; the bell end comprises a central axis and an interior sized to form an interference fit with a pin end disposed on a second tubular body of a second tubular member.

### FIELD

The present embodiments of the invention relate generally to a subsea mechanical joint.

### BACKGROUND

In the pipeline industry there is a need for a subsea mechanical joint between tubular members. This need also exists in other industries requiring the assembly of piping systems. The subsea mechanical joint eliminates the need for work site welding.

Additionally, in the deep water pipeline industry, there exists a need for having a fast setting epoxy compound within the subsea mechanical joint, allowing the mechanically joined tubular members to be deployed into deep water in a relatively short time period.

The joints of tubular members need to withstand harsh environmental conditions for a significant length of time. This is particularly true regarding subsea piping systems. Therefore, there exists a need for a subsea mechanical joint that is coated with a powder epoxy or a three layer polyethylene. The coating prevents environmental degradation to the mechanical joint, without the need for extra field assembly steps.

The present embodiments meet these needs.

### BRIEF DESCRIPTION OF THE DRAWINGS

The detailed description will be better understood in conjunction with the accompanying drawings as follows:

FIG. 1 depicts an exploded view of the subsea mechanical joint.

FIG. 2 depicts an alternative embodiment of the pin end.

FIG. 3 depicts a cut assembled view of the subsea mechanical joint.

The present embodiments are detailed below with reference to the listed Figures.

### DETAILED DESCRIPTION OF THE EMBODIMENTS

Before explaining the present embodiments in detail, it is to be understood that the embodiments are not limited to the particular embodiments and that they call be practiced or carried out in various ways.

The subsea mechanical joint includes a first tubular member having a bell end. The bell end includes a central axis, an interior sized to form an interference fit with a pin end of a second tubular member. The tubular member can be a schedule 40 pipe.

The second tubular member has a pin end, an exterior, including the pin end and the second tubular body, a tapered portion disposed between a pin end and a second tubular body, a central axis, and can include an annular groove formed within the second tubular body.

The bell end and pin end can have a smooth powder fusion bond epoxy coating, used on the outside of the pipe to prevent corrosion, such as that made by 3M such as Scotchlkote® 6233 disposed on them.

The present embodiment of the subsea mechanical joint can also include a liquid fast setting epoxy compound, such as a mixture of 85% epoxy resin and 15% inert ingredients for friction reduction, as a lubricant, and for pigmentation for use in assembling the tubulars. The fast setting epoxy compound can be applied to the interior of the bell end and the exterior of the pin end sequentially. The fast setting epoxy compound should fill the annular groove and the tapered portion of the pin end.

In an alternative embodiment, the fast setting epoxy compound can comprise a two part formulation which includes a base and an accelerator, such as product 135-8505, available from Bradley Coatings Group.

The base comprises approximately 60% epoxy resin, such as triglycidyl isocyanurate, by weight, approximately 2% dispersion agent, approximately 3% hydrocarbon resin, such as an aromatic hydrocarbon resin, approximately 4% titanium dioxide, approximately 15% micro-ciystalline filler, approximately 15% talc, and approximately 1% flatting agent, such as silica gel.

The accelerator comprises approximately 4% epoxy reactive diluent, such as 1,4-butanediol diglycidyl ether, by weight, approximately 10% of a hybrid reactive polyamide, for example UNI-REZ 1289 produced by Arizona Chemical, approximately 35% epoxy curing agent, such as an alkenyl or alkyl substituted succinic anhydride, approximately 10% dimethylamino-accelerator, approximately 1% phthalo blue dispersion, approximately 20% talc, and approximately 20% micro-ciystalline filler.

In another alternative embodiment of the subsea mechanical joint there is a first tubular member, such as schedule 40 pipe, having a bell end. The bell end includes a first outward flare disposed between the bell end and a first face, positioned above a central axis of the first bell end; and a second outward flare disposed between the first tubular body and a second face, disposed below the central axis, and an interior sized to form an interference fit with a second tubular member, which can also be a standard schedule 40 pipe, having a pin end. Other pipes, from as low as schedule 5 pipe to a maximum of schedule 80 pipe and even up to 160 pipe can be used.

In this embodiment, the second tubular member includes, the pin end, a central axis, an exterior, a tapered portion disposed between the pin end and the second tubular body, and can include an annular groove formed within the a second tubular body. A three layer polyethylene coating can be disposed on the first tubular member, including the bell end and the face of the bell end, and a portion of the second tubular member instead of solely a single layer of fusion bond material. The three layers would be the fusion bond material described above, a mastic and a polyethylene. The polyethylene can be high density polythene such as available from the Shell Chemical Company.

The interior of the bell end and exterior of the pin end can have a fast setting epoxy compound applied to them. The fast setting epoxy fills the space between the annular groove and an adjacent annular space between the tapered portion and the annular groove.

The interference fit should not generate a gripping force between the bell end and pin end that would cause the pin end to experience a stress greater than the elastic limit for each material used.

The embodiments of the current invention saves lives by eliminating the need for work site welding. Because the conditions of the work site are unpredictable, serious injury, or even death, can result from having welding equipment on the work site.

The embodiments of the invention save the environment by joining tubular members together with predictable mechanical joints that do not burst or leak when properly applied. When tubular members are welded together, the joints are sometimes unpredictable, which can result in the joint between the tubular members failing, causing the material transported within the pipes to leak or flow into the open environment. The transportation of oil in pipelines particularly requires that the tubular members making up the pipeline are joined together in a predictable manner, especially as the world's energy needs expand, increasing the need to retrieve or pipe oil from remote environmentally pristine areas. The present invention provide these benefits

Another benefit of the subsea mechanical joint is that it can be used to join tubular members made of steel, which have different levels of hardness. The invention can also be used to join soft materials, such as aluminum.

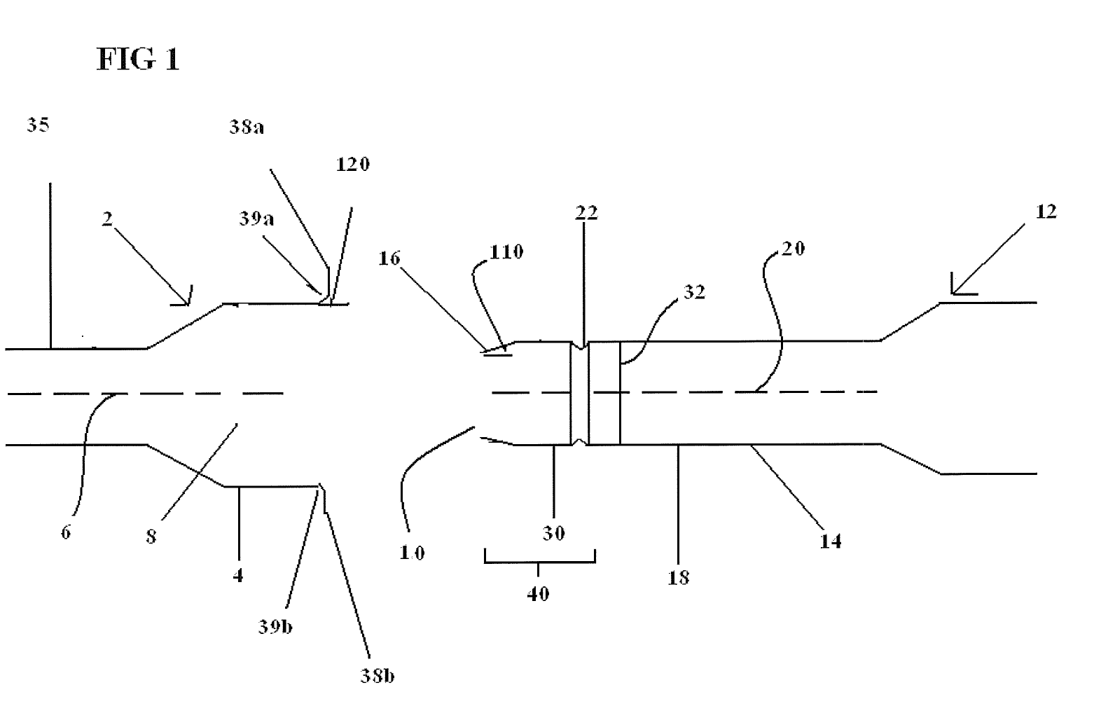

The subsea mechanical joint can be better understood with reference to the Figures. Referring now to FIG. 1, which depicts an exploded view of the subsea mechanical joint.

FIG. 1 depicts a first tubular member 2, and second tubular member 12 having a pin end 10. The first tubular member 2 has a first tubular body 35. The first tubular member 2 has a bell end 4 disposed on the first tubular body 35. The bell end 4 can include a central axis 6. The bell end has an interior 8, and a fast setting epoxy compound disposed on the interior. A coating is disposed on the first tubular body 12 and the bell end. The coating can be either the smooth powder fusion epoxy or the three layer polyethylene coating.

A second tubular member 12 is also depicted. The second tubular member 12 has a pin end 10 selectively which has a central axis 20 with a tapered portion 16 disposed between the pin end 10 and a second tubular body 18. Additionally, a fast setting epoxy compound is disposed on the pin end 10 and a coating, such as the three layer polyethylene coating or the smooth powder epoxy fusion bond coating is not disposed on a portion 40 of the second tubular body 18. The portion 40 can include the up to 0.05 inch past a depth insertion mark 32 towards the pin end 10 and extend all the way to the pin end 10.

Also shown is a exterior 14 which is an exterior for the pin end 10 and the tubular body 18, with an annular groove 22 and a depth insertion mark 32.

The tapered portion 16 can have an angle ranging from 0.5 degrees to 10 degrees, such as 3 degrees, relative to the central axis 20. The tapered portion 16 decreases in size in a small amount depending on the size of the pipe. The tapering occurs over about ½ inch of the length of the second tubular member 12, just at the end of the second tubular member 12.

The fast setting epoxy compound reduces galling of the bell end 4, which is located on the first tubular member 2, when the pin end 10 is inserted into the bell end 4.

The fast setting epoxy compound is disposed on the exterior 14 of the second tubular body on the pin end 10 and the interior 8 of the bell end 4 of the first tubular member 2.

The fast setting epoxy completely fills an annular groove 22 on the second tubular body 18 as well the adjacent area 30 located between the tapered end 16 and the annular groove 22.

The annular groove 22 is formed in an embodiment, by a hydraulic groover or machined into the pipe. The hydraulic groover is better than machining because no metal is removed from the pipe and no sharp edges are left on the pipe.

The annular groove 22 ensures a strong subsea mechanical joint because the groove acts as a reservoir to ensure that there is adequate fast setting epoxy compound to cover the entire end of the pipe.

The annular groove preferably has a depth ranging from 0.015 inches to 0.035 inches and a width ranging from 0.05 inches to 0.07 inches. In an embodiment, the annular groove can be located between ½ and 1 inch from the end of the pin end 10.

The fast setting epoxy acts as a lubricant and is a liquid epoxy and is applied to the interior of the bell end 4 and exterior 14 of the pin end 10, such that it is “holiday free”, that is free of voids in the coating, that is, there are no bare spots on the tubular to joined.

The subsea mechanical joint as disclosed allows for the fast setting epoxy to be applied to prevent damage to the tubular during the stabbing process of the pin end 10 into the bell end 4.

Particularly, the bell end 4 has a slight first outward flare 39a disposed between the bell end 4 and a first face 38a, which is above the central axis 6, and a second outward flare 39b disposed between the bell end 4 and a second face 38b, which is below the central axis 6. The first outward flare forms a outward flare angle 120 relative to the central axis 6. The second outward flare forms a substantially similar angle.

The tapered portion 16 has a small inward taper angle 110 relative to the central axis 20. The outward flare angle 120 can be any angle less than the tapered angle. Good results have been experienced when a joint was made using a tapered end having an angle of 3 degrees and a flare on the bell end of 4 degrees for a joint on 6 inch diameter pipe wherein the stabbed in, overlapping portion of the joint an overall length between 7 and 10 inches, about 9.5 inches.

The fast setting epoxy compound allows the subsea joint to be quickly submergible into deep water of a depth ranging from approximately 300 feet to 1000 feet after the tubular ends have been joined because of this coating. The setting time, the curing time of the coating on the pipe can occur in a relatively short period usually ranging from in as little as 8 seconds or as much as 25 seconds. Because the cure time is very short, the pipe can be quickly submerged, whereas it takes several hours with traditional, slower setting compounds.

FIG. 1 also shows a first portion 40 of the second tubular body 18 and the pin end 10 not covered by the smooth fusion epoxy coating or the 3 layer polyethylene. The portion of the tubular body not covered should start approximately 0.5 inches past a depth insertion mark 32 on the side of the depth insertion mark closest to the annular groove 22 and extend to the end of the pin end 10.

Additionally in FIG. 1, the depth insertion mark 32 is shown, which indicates how far the pin end 10 should be stabbed into the bell end 4.

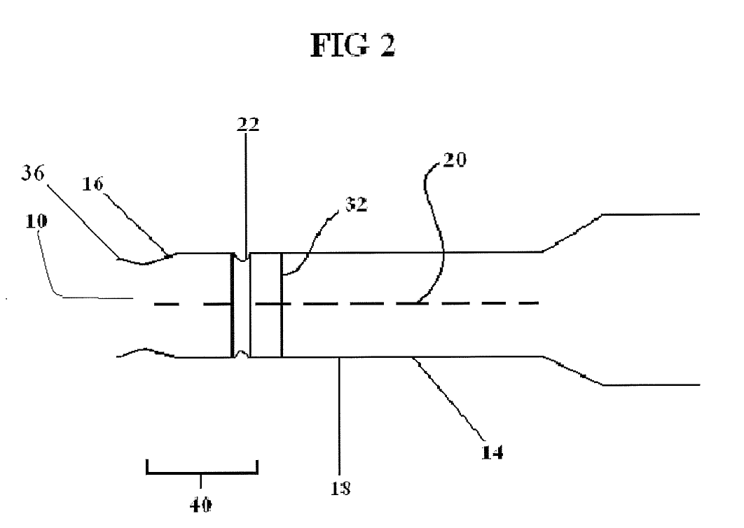

FIG. 2 depicts an alternative embodiment of the pin end 10.

In this FIG. 2, the pin end 10 has a central axis 20; a tapered portion 16; the second tubular body 18; a fast setting epoxy compound, such as a mixture of 85% epoxy resin and 15% inert ingredients for fiiction reduction and pigmentation. Additionally, FIG. 2 shows an inverted bevel 36. The inverted bevel 36 is a tapered edge where the inside shoulder of the pin end has been removed. The inverted bevel is used to improve the geometry of the inside of the pipe joint. Also shown in the FIG. 2 is the exterior 14, the annular groove 22, and the depth insertion mark 32.

The second tubular body 18 can be coated with a coating, which can be a smooth powder fusion epoxy or a three layer polyethylene, with a portion 40 of the second tubular body 18 and the pin end 10 without the coating.

The inverted bevel 36 is prefabricated by a steel manufacturer of the entire tubular member. The inverted bevel does not have to done in prefabrication and can be done by another party, after the pipe has been created by the pipe manufacturer. The inverted bevel 36 has the benefit of improving the hydraulic efficiency through the joint.

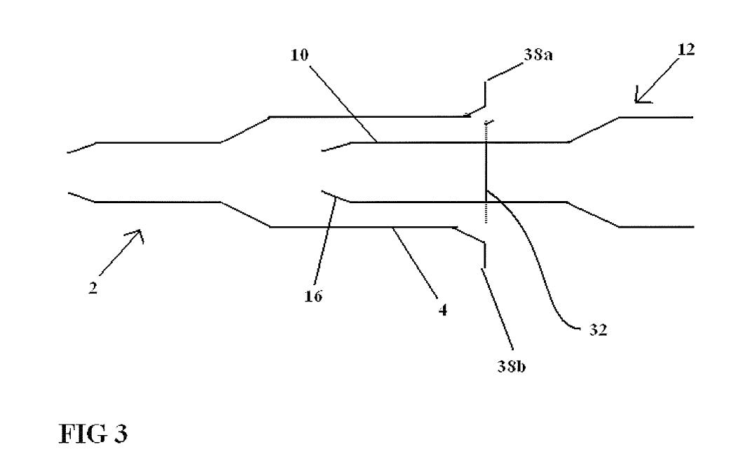

FIG. 3 depicts an assembled subsea mechanical joint with the pin end 10 of the second tubular member 12 inserted into the bell end 4 of the first tubular member 2. When the pin end 10 is inserted into the bell end 4 an interference fit is formed. The advantage of the interference fit is to provide a fit that prevents leaking. No threading or welding is needed when this interference fit is made. Force is used to create the interference fit, such as a hydraulic press. This type of sealing engagement insures a tight, leak proof seal. The interference fit process is faster than other types of pipe joining. Additionally, by using interference fits, there is no need to perform x-rays to detect cracks or hairline fractures in a weld because no weld is made. Additionally, FIG. 3 depicts the depth insertion mark 32 aligned perpendicularly to a first face 38a and a second face 38b.

It is contemplated that the pin end 10 can have an insertion depth of between 5 inches to 14 inches into the bell end 4 depending on the size, the diameter of the pipe.

In this alternative embodiment of the subsea mechanical joint, the tapered end 16 can have an angle ranging from 0.5 degrees to 16 degrees.

In yet another alternative embodiment of the subsea mechanical joint, it is further contemplated that the bell end 4 can have an inner diameter of not less than the outer diameter of the pin end 10 less the product of 0.005 times the outer diameter of the second tubular member 12.

For example, but with out limitation, a “minimum interference fit” for steel has been determined to be approximately 0.005 inches of outside diameter per 30,000 pounds per square inch of minimum specified yield.

An embodiment contemplates using 0.003 inch, but 0.005 was used to compensate for miscellaneous irregularities which may be found in the tubular member.

For example, for a nominal 4.5 inch diameter pipe, the standards on such pipe allow a tolerance of plus or minus 0.75%. A 4.5 inch diameter pipe with A.P.I. standards may thus be encountered with an outside diameter as small as 4.46625 inches. Thus, to allow for the minimum desired interference of 0.0225 inches, the bell end must be expanded such that its dimension after “snap-back” is approximately 4.44 inches. Such sizing to obtain a “minimum interference fits has been found to satisfactorily accommodate pin ends of pipe with a maximum positive A.P.I. variation without significantly increasing the force required for joining, and while maintaining an adequate gripping force.

The relationship described above may be expressed as follows:

a. B.D.=Min. O.D. pin-0.005X, where

b. B.D.=bell inner diameter in inches;

c. Min O.D pin=smallest pin end outer diameter;

d. X=Nominal second tubular member outer diameter.

The invention also relates to a method for forming a subsea mechanical joint.

An embodiment of the method for forming a subsea mechanical joint can include forming a bell end in the end portion of a first tubular member. The bell end can receive a pin end of a second tubular member.

An embodiment of the method can include yielding the end portion of the first tubular member forming the bell end sized to receive the pin end of the second tubular member with an interference fit.

The yielding of the end portion of the first tubular member can be accomplished by using a hydraulic press, which exerts a pressure between the mandrel and end of the pipe. The hydraulic press exerts a force ranging from 10 to 50 tons, forcing the mandrel into the end portion of the first tubular member, causing it to yield. The mandrel is sized according to the tubular member that is used. The mandrel is made of hardened steel.

The present embodiment of the method can further include deforming the end portion of the second tubular member, which forms the pin end. The pin end can have a tapered portion.

The deforming operation can be accomplished by using a roll forming machine. The roll forming machine can have rollers. The rollers control the angle of the tapered portion of the pin end.

The present embodiment can also include forming an annular groove. The annular groove is formed by a ridge on the roller. The annular groove can be located on the exterior of a tubular body. The annular groove should be located as proximate to the tapered portion as practicable.

It is contemplated that the annular groove can be disposed within the bell end when the interference fit is made.

The first tubular member is coated with smooth powder fusion epoxy. The second tubular member is also coated with the smooth powder fusion epoxy, such as Scotchkote™ 6233, manufactured by 3M.

Simultaneously during the coating of the second tubular member the act of masking a portion of the second tubular member is performed which prevents the smooth fusion bond powder epoxy coating from disposing on the pin end and part of the second tubular body.

The portion that is masked is a space from up to 0.05 inches from a depth insertion mark towards the annular groove and extending to the end of the pin end.

The smooth fusion epoxy coating can be a thermosetting epoxy powder coating.

In an alternative embodiment a three layer polyethylene coating system can be used.

It is further contemplated that a first outward flare for receiving the pin end can be formed between the bell end and a first face, disposed above a central axis. A second outward flare for receiving the pin end can be formed between the bell end and a second face, disposed below the central axis. It is contemplated that in one embodiment these parts are coated with the smooth fusion powder epoxy and in a second embodiment with a three layer polyethylene.

The present embodiment of the method further includes applying a fast setting epoxy compound, such as a mixture of 85% epoxy resin and 15% inert ingredients for friction reduction and pigmentation, to the interior of the bell end and the exterior of the pin end.

The fast setting epoxy compound can be a compound having a fast curing time. The fast setting epoxy compound can be mixed using a machine that meters and mixes the fast setting epoxy compound and delivers it to a nozzle for the application of the fast setting epoxy compound to the tubular member by hand.

The fast setting epoxy compound should be applied so that when the interference fit is made, the fast setting epoxy compound fills the annular groove and an adjacent annular space between the tapered portion and the annular groove. The fast setting epoxy compound can be set in a span of time ranging from 1 minute to 10 minutes.

The present embodiment of the method also includes inserting the pin end into the bell end, creating the interference fit. The pin end is inserted into the bell end by using a hydraulic press.

When in the interference fit, the bell end exerts a compressive force on the pin end. The compressive force is usually less than the yield strength of the pin end. The pressure exerted on the pin end forms the subsea mechanical joint between the first tubular member and the second tubular member. The subsea mechanical joint is capable of withstanding a pressure equal to that of the first tubular member and second tubular member.

An alternative embodiment of the method can include coating the exterior of the first tubular member, including the bell end, and the entire second tubular member with a three layer polyethylene. Instead of applying the smooth fusion powder epoxy. Additionally the alternative embodiment can include removing a portion of the three layer polyethylene from the pin end.

In another alternative embodiment of the method further includes deforming the pin end and bell end relative to each other. This ensures that when the pin end and bell end are interfitted, they will have a minimum interference fit there between.

During the yielding of the end portion of the first tubular member, the bell end is strain hardened, which increases the yield strength of the end portion by up to about 10 percent.

It is also contemplated that the method can include applying a depth insertion mark to the second tubular body during coating. The insertion depth can be controlled by using the hydraulic press and stopping the hydraulic press when the depth insertion mark is perpendicular with the first face and second face of the bell end.

It is contemplated that the fast setting epoxy can set within a span of time ranging from 1 minute to 10 minutes.

It is also contemplated that the removed portion of the three layer polyethylene coating can range from 2 inches to 15 inches in length.

In an embodiment of the invention, the thickness of the smooth fusion bond powder epoxy coating can be thicker at the bell end and pin end than at the middle of the tubular members.

It is also contemplated that the deforming of the pin end can be accomplished by using a roll forming machine. The roll forming machine can have a set of rollers with pitch angles varying from 0.5 degrees to 10 degrees depending on whether the pipe is internally coated or not.

While these embodiments have been described with emphasis on the embodiments, it should be understood that within the scope of the appended claims, the embodiments might be practiced other than as specifically described herein.

What is claimed is:

1. A tubular subsea mechanical joint comprising:
a first tubular member comprising a bell end disposed a first tubular body; the bell end comprises a central axis and an interior sized to form an interference fit with a pin end disposed on a second tubular body of a second tubular member;
wherein second tubular member comprises the pin end, an exterior, a tapered portion disposed between the pin end and the second tubular body, and an annular groove formed within the second tubular body;
a smooth fusion bond powder epoxy coating disposed on the bell end, the first tubular body, and the second tubular body excluding a portion of the second tubular body;
a fast setting epoxy compound applied to the interior of the bell end and the pin end that fills the annular groove and an adjacent space between the annular groove and the tapered portion.

2. The tubular subsea mechanical joint of claim 1, wherein the second tubular member further comprises a depth insertion mark located on the second tubular body.

3. The tubular subsea mechanical joint of claim 2, wherein the portion of the second tubular member not comprising the smooth powder fusion epoxy comprises from up to 0.05 inches past the depth insertion mark towards the annular groove and extends to the pin end.

4. The tubular subsea mechanical joint of claim 3, wherein the depth insertion mark is disposed on the second tubular body to allow for a depth of insertion of the pin end into the bell end ranging from 3 inches to 15 inches.

5. The tubular subsea mechanical joint of claim 4, wherein the bell end further comprises a first outward flare disposed between the bell end and a first face, wherein the first outward flare is disposed above a central axis of the first bell end; and a second outward flare disposed between the bell end and a second face, and wherein the second outward flare is disposed below the central axis.

6. The tubular subsea mechanical joint of claim 5, further comprising the pin end disposed within the bell end so that the depth insertion mark aligns perpendicularly to the first face and second face.

7. The tubular subsea mechanical joint of claim 1, wherein the tapered portion further comprises an angle ranging from 0.5 degrees to 10 degrees relative to the central axis of the pin end.

8. The tubular subsea mechanical joint of claim 1, wherein the bell end comprises an inside diameter not less than an outer diameter of the pin end less the product of 0.005 times an outer diameter dimension of the second tubular member.

9. The tubular subsea mechanical joint of claim 8, wherein the pin end further comprises an inverted bevel disposed on the tapered portion of the pin end.

10. The tubular subsea mechanical joint of claim 1, wherein the fast setting epoxy compound comprises substantially equal amounts of an epoxy base and an epoxy accelerator, wherein the epoxy base comprises:
an epoxy resin, wherein the epoxy resin comprises approximately 60 weight percent of the epoxy base based on the total weight of the epoxy base;
a dispersion agent, wherein the dispersion agent comprises approximately 2 weight percent of the epoxy base based on the total weight of the epoxy base;
a hydrocarbon resin, wherein the hydrocarbon resin comprises approximately 3 weight percent of the epoxy base based on the total weight of the epoxy base;
a titanium dioxide, wherein the titanium dioxide comprises approximately 4 weight percent of the epoxy base based on the total weight of the epoxy base;
a micro-crystalline filler, wherein the micro-crystalline filler comprises approximately 15 weight percent of the epoxy base based on the total weight of the epoxy base;
a talc, wherein the talc comprises approximately 15 weight percent of the epoxy base based on the total weight of the epoxy base; and
a flatting agent, wherein the flatting agent comprises approximately 1 weight percent of the epoxy base based on the total weight of the epoxy base; and
wherein the epoxy accelerator comprises:
an epoxy reactive diluent, wherein the epoxy reactive diluent comprises approximately 4 weight percent of the epoxy accelerator based on the total weight of the epoxy accelerator;
a hybrid reactive polyamide, wherein the hybrid reactive polyamide comprises approximately 10 weight percent of the epoxy accelerator based on the total weight of the epoxy accelerator;
an epoxy curing agent, wherein the epoxy curing agent comprises approximately 35 weight percent of the epoxy accelerator based on the total weight of the epoxy accelerator;
a dimethylamino-accelerator, wherein the dimethylamino-accelerator comprises approximately 10 weight percent of the epoxy accelerator based on the total weight of the epoxy accelerator;
a phthalo blue dispersion agent, wherein the phthalo blue dispersion agent comprises approximately 1 weight percent of the epoxy accelerator based on the total weight of the epoxy accelerator;
a talc, wherein the talc comprises approximately 20 weight percent of the epoxy accelerator based on the total weight of the epoxy accelerator; and
a micro-crystalline filler, wherein the micro-crystalline filler comprises approximately 20 weight percent of the epoxy accelerator based on the total weight of the epoxy accelerator.

11. A subsea mechanical joint comprising:
a first tubular member comprising a bell end disposed on a first tubular body; the bell end comprises a central axis, and an interior sized to form an interference fit with a pin end disposed on a second tubular body of a second tubular member;
wherein the second tubular body comprises an exterior, a tapered portion disposed between the pin end and the second tubular body, and an annular groove formed within the second tubular body;
a three layer polyethylene coating disposed on the bell end, the first tubular body, and on the second tubular body excluding a portion of the second tubular body;
a fast setting epoxy compound applied to the interior of the bell end and the pin end that fills the annular groove and an adjacent space between the annular groove and the tapered portion.

12. The tubular subsea mechanical joint of claim 11, wherein the second tubular member further comprises a depth insertion mark located on the second tubular body.

13. The tubular subsea mechanical joint of claim 12, wherein the portion of the second tubular member not comprising the smooth powder fusion epoxy comprises from up to 0.5 inches past the depth insertion towards the annular groove and extends to the pin end.

14. The tubular subsea mechanical joint of claim 13, wherein the depth insertion mark is disposed on the second tubular body to allow for a depth of insertion of the pin end into the bell end ranging from 3 inches to 15 inches.

15. The tubular subsea mechanical joint of claim 14, wherein the bell end further comprises a first outward flare disposed between the bell end and a first face, wherein the first outward flare is disposed above a central axis of the first bell end, and a second outward flare disposed between the bell end, and wherein the second outward flare is disposed below the central axis.

16. The tubular subsea mechanical joint of claim 15, further comprising the pin end disposed within the bell end so that the depth insertion mark aligns perpendicularly to the first face and second face.

17. The tubular subsea mechanical joint of claim 11, wherein the tapered portion further comprises an angle ranging from 0.5 degrees to 10 degrees relative to the central axis of the pin end.

18. The tubular subsea mechanical joint of claim 11, wherein the bell end comprises an inside diameter not less than an outer diameter of the pin end less the product of 0.005 times an outer diameter dimension of the second tubular member.

19. The tubular subsea mechanical joint of claim 18, wherein the pin end further comprises an inverted bevel disposed on the tapered portion of the pin end.
